(19) United States
(12) Patent Application Publication
(10) Pub. No.: US 2008/0078162 A1
(43) Pub. Date: Apr. 3, 2008

(54) TURBINE EXHAUST CASE COWLING FOR A GAS TURBINE ENGINE

(76) Inventors: Guy LEFEBVRE, Saint-Bruno (CA); Eric Durocher, Vercheres (CA)

Correspondence Address: OGILVY RENAULT LLP (PWC), 1981 MCGILL COLLEGE AVENUE, SUITE 1600, MONTREAL, QC, H3A 2Y3, US

(21) Appl. No.: 11/536,162

(22) Filed: Sep. 28, 2006

(51) Int. Cl. F02K 3/02

(52) U.S. Cl. 60/226.1; 60/770

(57) ABSTRACT

The cowling is used around a turbine exhaust case in gas turbine engine. It comprises a substantially conical wall with a longitudinal split forming opposite ends. Each end is directly unconnectable to each other.

### TECHNICAL FIELD

The invention relates to a cowling, and in particular to an improved turbine exhaust case cowling for use in a gas turbine engine.

### BACKGROUND

A turbofan gas turbine engine generally comprises a by-pass duct in which flows a portion of the air coming from the fan at the inlet of the engine. The by-pass air flows around the core of the engine. In the engine core, the compressed air is mixed with fuel and ignited to generate hot combustion gases from which energy is extracted by one or more turbines stages.

In some gas turbine engines, a cowling is provided around the turbine exhaust case. This cowling is also called a core cowl or a rear inner by-pass duct. The cowling provides a streamlined enclosure around the turbine exhaust case and also provides a thermal barrier for the turbine exhaust case. The cowling is used in conjunction with a service fairing which extends radially within the by-pass flow to protect oil pipes and other tubes and cables required at the rear end of the engine. The service fairing is a streamlined rigid element in registry with a hole in the cowling. The cowling itself comprises a longitudinal split joint where opposite ends are attached by brackets. The brackets and corresponding connectors are provided around the opening for the service fairing. The split joint allows the cowling to be extended radially when installing it around the turbine exhaust case or removing it for maintenance.

Overall, it was desirable to have an improved turbine exhaust case cowling with a new design of the junction with a service fairing.

### SUMMARY

In one aspect, the present concept provides a cowling for use around a turbine exhaust case in gas turbine engine, the cowling comprising a substantially conical wall with a longitudinal split forming opposite ends, each end being directly unconnectable to each other.

In another aspect, the present concept provides a cowling assembly for a turbine exhaust case of a gas turbine engine, the cowling assembly comprising: a core cowl having a substantially longitudinal split forming two opposite ends; a vibration absorbing member connected to each end; and a service fairing interposed between the opposite ends of the core cowl, each end of the core cowl being in contact with the service fairing through the corresponding vibration absorbing member, both ends being spaced apart when the assembly is completed.

In a further aspect, the present concept provides a method of assembling a cowling for a turbine exhaust case in a gas turbine engine, the cowling including a substantially conical wall with a split forming two opposite and longitudinally extended ends, the method comprising: gluing a vibration absorbing member on each end of the cowling; adjoining each end of the cowling on the corresponding side of the service fairing; and securing the service fairing and the cowling with the turbine exhaust case, the ends of the cowling remaining unconnected to each other.

Further details of these and other aspects of the improved turbine exhaust case cowling will be apparent from the detailed description and figures included below.

### BRIEF DESCRIPTION OF THE FIGURES

For a better understanding and to show more clearly how it may be carried into effect, reference will now be made by way of example to the accompanying figures, in which:

FIG. 1 schematically shows a generic gas turbine engine to illustrate an example of a general environment in which the improved turbine exhaust case cowling can be used;

FIG. 2 is a front perspective view of an example of an improved cowling with some of its supporting brackets;

FIG. 3 is a rear perspective view showing the cowling of FIG. 2 installed on an example of a turbine exhaust case;

FIG. 4 shows the vibration absorbing members used in the cowling of FIG. 3; and

FIG. 5 is an enlarged view showing the cowling assembly of FIG. 3.

### DETAILED DESCRIPTION

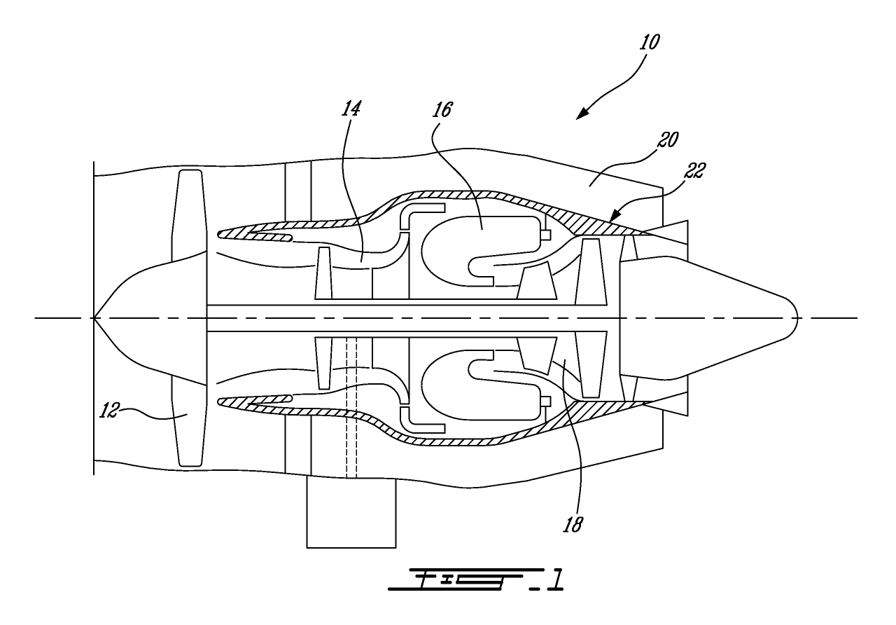

FIG. 1 illustrates a gas turbine engine 10 of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases. The engine 10 comprises a by-pass duct 20 located around the core of the engine 10. FIG. 1 only shows one example of the general environment in which the improved turbine exhaust case cowling can be used. The improved turbine exhaust case cowling can be used with other turbofan models. In the specific example of FIG. 1, the turbine exhaust case cowling is used in the region generally identified with reference numeral 22.

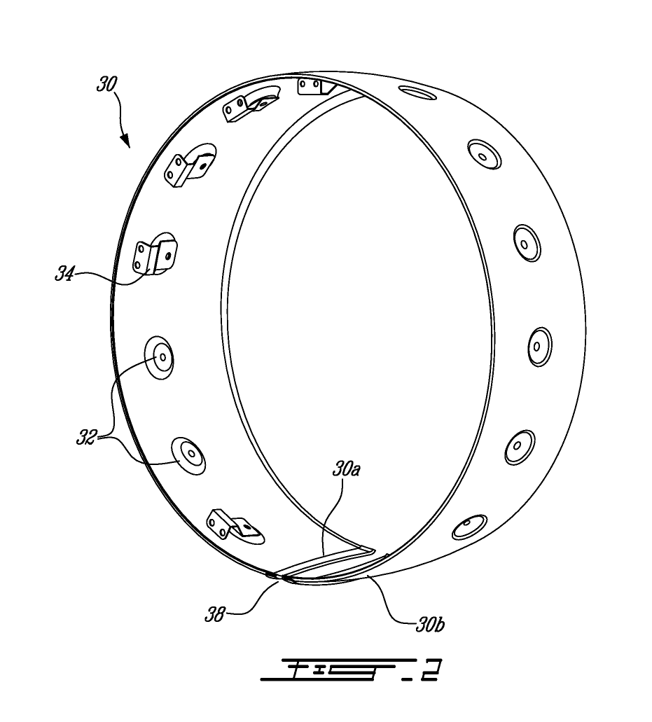

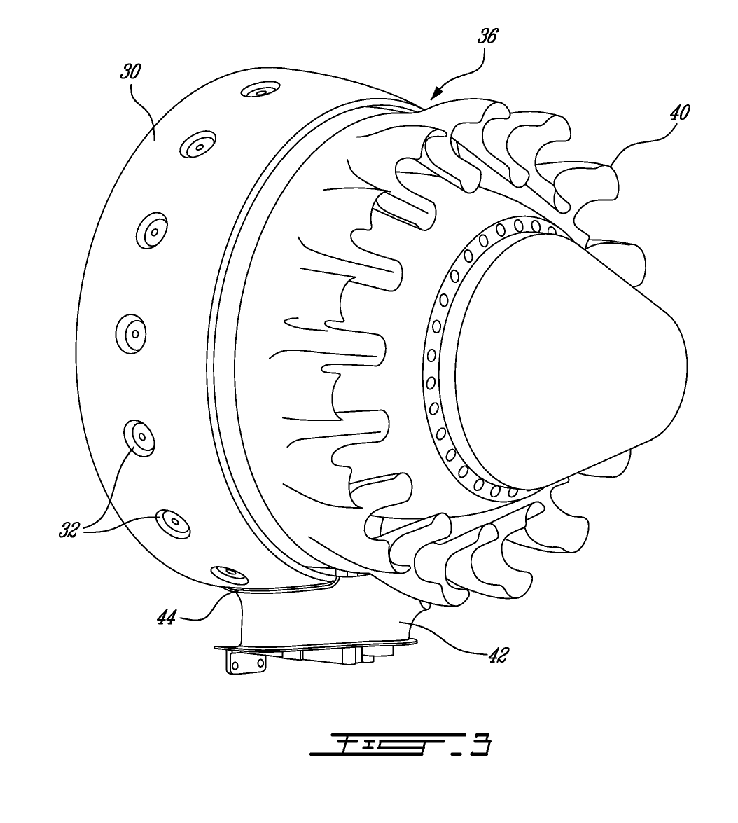

Referring now to FIG. 2, there is shown an example of a cowling 30 as improved herein. The cowling 30 is generally made of sheet metal shaped into a substantially conical element. The cowling 30 of FIG. 2 has a plurality of circumferentially disposed bosses 32 to which brackets 34 can be connected for supporting the cowling 30 around a turbine exhaust case 36 (FIG. 3). It should be noted that in FIG. 2, only a few of the brackets 34 are shown. The connection between the cowling 30 and the brackets 34 includes fasteners (not shown).

The cowling 30 has a longitudinal split 38 through its wall. The split 38 forms two opposite ends 30a, 30b provided with a generally straight edge. With the split 38, it is possible to increase the diameter of the cowling 30 during installation or in view of its removal during maintenance. However, as explained hereafter, both ends 30a, 30b remain unconnected to each other even once the cowling 30 is installed within the engine 10.

FIG. 3 shows an example of a turbine exhaust case 36 with an improved cowling assembly. This figure shows the lobbed exhaust 40 from which the combustion gases flow out of the engine. This is also the location where the by-pass air flow mixes with the hot combustion gases.

A service fairing 42 is located usually at the bottom of the engine 10 for protecting the pipes and other tubes and cables required at the rear end of the engine core. The service fairing 42 is a streamlined rigid element extending between the inner side and the outer side of the by-pass duct 20.

In the improvement, the service fairing 42 is also used to hold the opposite ends 30a, 30b of the cowling 30. The opposite ends 30a, 30b fit into a corresponding side of the service fairing 42. However, vibration absorbing members 44 are provided between the ends of the cowling 30 and the service fairing 42. The vibration absorbing members 44 are made of a damping material capable of withstanding the relatively high temperatures at the rear of the engine 10.

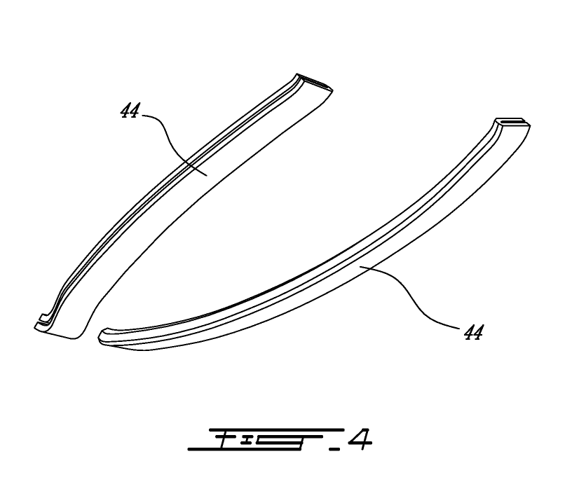

FIG. 4 shows an example of vibration absorbing members 44 that are connected on the ends of the cowling 30. The members 44 substantially extend over the entire corresponding end. They are preferably glued to the corresponding end. For instance, one can use a temperature resistant silicone glue for that purpose.

Before installation of the cowling 30, the vibration absorbing members 44 are glued on corresponding ends 30a, 30b of the cowling 30. Each end is then adjoined to the corresponding side of the service fairing 42. The service fairing 42 and the cowling 30 are attached to the turbine exhaust case thereafter.

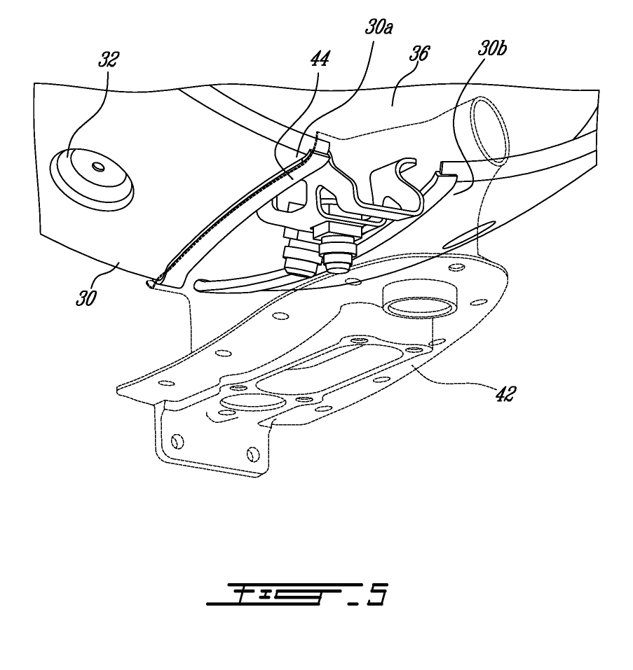

FIG. 5 shows the resulting assembly, which assembly is also shown in FIG. 3. As can be seen, the ends of the cowling 30 are connected to the service fairing 42 through the vibration absorbing members 44. The ends 30a, 30b of the cowling 30 are not directly connected to each other. This reduces vibrations and improves the lifespan of the cowling 30.

The above description is meant to be exemplary only, and one skilled in the art will recognize that other changes may also be made to the embodiments described without departing from the scope of the invention disclosed as defined by the appended claims. For instance, the present invention is not limited to a cowling having a specific shape as the one illustrated in the figures. The service fairing can also have a different shape than that illustrated herein. The edges at the ends of the cowling can have a different shape than that illustrated and described. For instance, the ends can be curved or irregular, depending on the design. The vibration absorbing member can be provided within the service fairing and permanently connected to it instead of being connected to the cowling. The glue, especially the silicone glue, is only one example of a possible connection between the vibration absorbing member and the surrounding parts. Other kinds of connectors can be used as well, for instance bolts, rivets, etc. The brackets illustrated for supporting the cowling are only shown as an example. Other kinds of supporting devices can also be used as well. Although the engine as illustrated was primarily designed for operation at less than 600° F., it is possible to increase the operating temperature by using appropriate materials. The rear of the engine as illustrated in FIG. 3 is only shown as an example. Still other modifications which fall within the scope of the present invention will be apparent to those skilled in the art, in light of a review of this disclosure, and such modifications are intended to fall within the appended claims.

What is claimed is:

1. A cowling for use around a turbine exhaust case in gas turbine engine, the cowling comprising a substantially conical wall with a longitudinal split forming opposite ends, each end being directly unconnectable to each other.

2. The cowling as defined in claim 1, wherein each end defines a generally straight edge.

3. The cowling as defined in claim 2, wherein a vibration absorbing member is connected to each edge.

4. The cowling as defined in claim 3, wherein each vibration absorbing member substantially extends over the entire corresponding edge.

5. The cowling as defined in claim 3, wherein the vibration absorbing material is glued to the corresponding edge.

6. A cowling assembly for a turbine exhaust case of a gas turbine engine, the cowling assembly comprising:
a core cowl having a substantially longitudinal split forming two opposite ends;
a vibration absorbing member connected to each end; and
a service fairing interposed between the opposite ends of the core cowl, each end of the core cowl being in contact with the service fairing through the corresponding vibration absorbing member, both ends being spaced apart when the assembly is completed.

7. A method of assembling a cowling for a turbine exhaust case in a gas turbine engine, the cowling including a substantially conical wall with a split forming two opposite and longitudinally extended ends, the method comprising:
gluing a vibration absorbing member on each end of the cowling;
adjoining each end of the cowling on the corresponding side of the service fairing; and
securing the service fairing and the cowling with the turbine exhaust case, the ends of the cowling remaining unconnected to each other.
